(19) United States
(12) Patent Application Publication
(10) Pub. No.: US 2018/0186453 A1
(43) Pub. Date: Jul. 5, 2018

(54) Unmanned Aerial Vehicle Line Charge Deployment System and Method

(71) Applicant: Critical Solutions International, Inc., Charleston, SC (US)

(72) Inventors: Arnis Mangolds, Stow, MA (US); Benjamin Harris, Lexington, SC (US); Scott Ogle, Dixon, MO (US); Tyler Sammis, Mount Pleasant, SC (US)

(21) Appl. No.: 15/395,193

(22) Filed: Dec. 30, 2016

(51) Int. Cl. B64D 1/06; B64C 39/02; F42B 3/093

(52) U.S. Cl. CPC B64D 1/06; B64C 39/024; B64C 2201/121; B64C 2201/024; B64C 2201/108; F42B 3/093

(57) ABSTRACT

An unmanned aerial vehicle line charge deployment system includes an unmanned aerial vehicle, a payload bay mounted beneath the unmanned aerial vehicle, and a line charge release subsystem coupled to the payload bay. A first line charge release mechanism releasably secures a first portion of a line charge to the unmanned aerial vehicle payload bay and a second line charge release mechanism, independent from the first line charge release mechanism, releasably secures a second portion of the line charge to the unmanned aerial vehicle payload bay.

### FIELD OF THE INVENTION

The subject invention relates to line charge deployment mechanisms and methods.

### BACKGROUND OF THE INVENTION

Explosive line charges can be used to clear buried mines, expose improvise explosive devices, breach walls or fences, or the like. See U.S. Pat. No. 8,904,937 incorporated herein by this reference.

U.S. Pat. No. 5,675,104 (incorporated herein by this reference) relates to an explosive array deployed from an airplane or rocket motor. U.S. Pat. No. 4,776,255 (incorporated herein by this reference) relates to a projectile used to deploy an explosive line. U.S. Pat. No. 8,714,069 (incorporated herein by this reference) relates to a two-wheeled ground vehicle used to deploy a line charge.

### SUMMARY OF THE INVENTION

Existing aerial based line charge deployment systems may not be able to precisely deploy a line charge. They may not be able to, for example, drape a line charge over a barrier such as a fence or wall in a manner sufficient to provide a wide area breach of the barrier enabling ground vehicles to pass.

Existing ground vehicle based line charge deployment systems cannot drape a line charge over a barrier such as a wall.

Featured in one example is a line charge deployment system and method capable of more precisely deploying a line charge from an unmanned aerial vehicle. The two ends of the line charge can be reliably positioned at different selected deployment positions on or proximate a target for improved effectiveness.

The subject invention, however, in other embodiments, need not achieve all these objectives and the claims hereof should not be limited to structures or methods capable of achieving these objectives.

Featured is an unmanned aerial vehicle line charge deployment system comprising an unmanned aerial vehicle, a payload bay mounted beneath the unmanned aerial vehicle, and a line charge release subsystem coupled to the payload bay. The line charge release subsystem includes a first line charge release mechanism for releasably securing a first portion of a line charge to the unmanned aerial vehicle payload bay and a second line charge release mechanism, independent from the first line charge release mechanism, for releasably securing a second portion of the line charge to the unmanned aerial vehicle payload bay.

In one example, the first line charge release mechanism includes a housing with a first open-ended chamber therein, a first piston, and a first actuator for driving the first piston into the first open-ended chamber releasably locking the first portion of the line charge in the first open-ended chamber and for retracting the first piston with respect to the first open-ended chamber releasing the first portion of the line charge from the first open-ended chamber. In this example, the second line charge release mechanism may include a second open-ended chamber in the housing, a second piston, and a second actuator for driving the second piston into the second open-ended chamber releasably locking the second portion of the line charge in the second open-ended chamber and for retracting the second piston with respect to the second open-ended chamber releasing the second portion of the line charge from the second open-ended chamber.

Also featured is an unmanned aerial vehicle line charge release subsystem comprising, in one example, a first line charge release mechanism mountable to an unmanned aerial vehicle and configured to releasably secure a first portion of a line charge with respect to the unmanned aerial vehicle and to release the first portion of the line charge from the unmanned aerial vehicle. A second line charge release mechanism is mountable to the unmanned aerial vehicle and is configured to releasably secure a second portion of the line charge with respect to the unmanned aerial vehicle and to independently release the second portion of the line charge from the unmanned aerial vehicle.

Also featured is a method of more precisely deploying a line charge. The method may include releasably securing a first portion of the line charge with respect to an unmanned aerial vehicle and releasably securing a second portion of the line charge with respect to the unmanned aerial vehicle. The unmanned aerial vehicle is maneuvered to a first position proximate a target and the first portion of the line charge is released from the unmanned aerial vehicle to a first deployment position. The unmanned aerial vehicle is then maneuvered to a second position proximate the target and the second portion of the line charge is released from the unmanned aerial vehicle to a second deployment position.

Releasably securing the first portion of the line charge to the unmanned aerial vehicle may include extending a first piston to secure the first portion of the line charge relative to the unmanned aerial vehicle and releasing the first portion of the line charge from the unmanned aerial vehicle may include retracting the first piston. Releasably securing the second portion of the line charge to the unmanned aerial vehicle may include extending a second piston to secure the second portion of the line charge relative to the unmanned aerial vehicle and releasing the second portion of the line charge from the unmanned aerial vehicle may include retracting the second piston. The method may further include detonating the line charge remotely, via a tethered initiator, or using time/safety fusing.

Also featured is an unmanned aerial vehicle line charge deployment system comprising an unmanned aerial vehicle, a payload bay mounted beneath the unmanned aerial vehicle, and a line charge release subsystem coupled to the payload bay. The line charge release subsystem includes a first line charge release piston for releasing a first portion of a line charge from the unmanned aerial vehicle payload bay, and a second line charge release piston for releasing a second portion of the line charge from the unmanned aerial vehicle payload bay.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1A is a schematic view showing an unmanned aerial vehicle (UAV), in one example, maneuvered into position with respect to a target barrier;

FIG. 1B is a schematic view showing one end of a line charge deployed to a first deployment position;

FIG. 1C is a schematic view showing how the UAV can be maneuvered to drape the line charge over the target barrier;

FIG. 1D is a schematic view showing the second end of the line charge now deployed to a second deployment position;

FIG. 1E is a schematic view showing a breach in the target barrier after remotely detonating the line charge;

FIG. 2 is a schematic view showing one example of a line charge deployment system;

FIG. 3 is a schematic view showing the underside of the line charge deployment system of FIG. 2;

FIG. 4 is a schematic view showing an embodiment with dual pistons extendable into and retractable from dual open ended chambers for securing different portions of the line charge therein;

FIG. 5 is a schematic partially cut-away view showing a piston extended through a loop associated with one end of a line charge;

FIG. 6 is a schematic view showing a line charge being deployed from a UAV; and

FIGS. 7-9 are views of examples of line charge deployment profiles possible using the subject invention.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

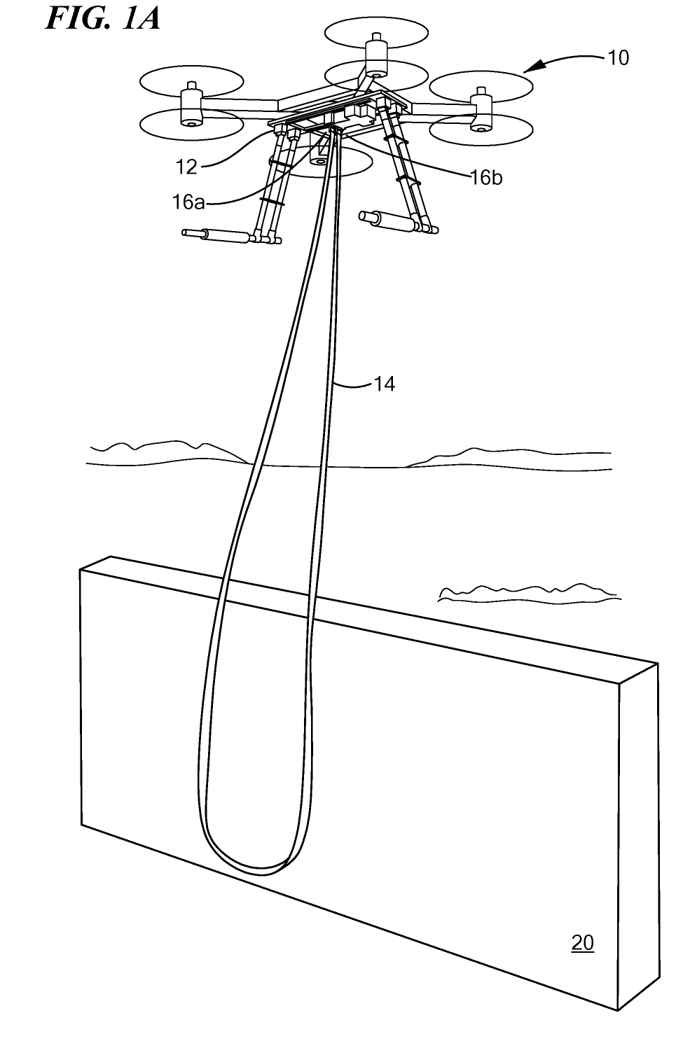

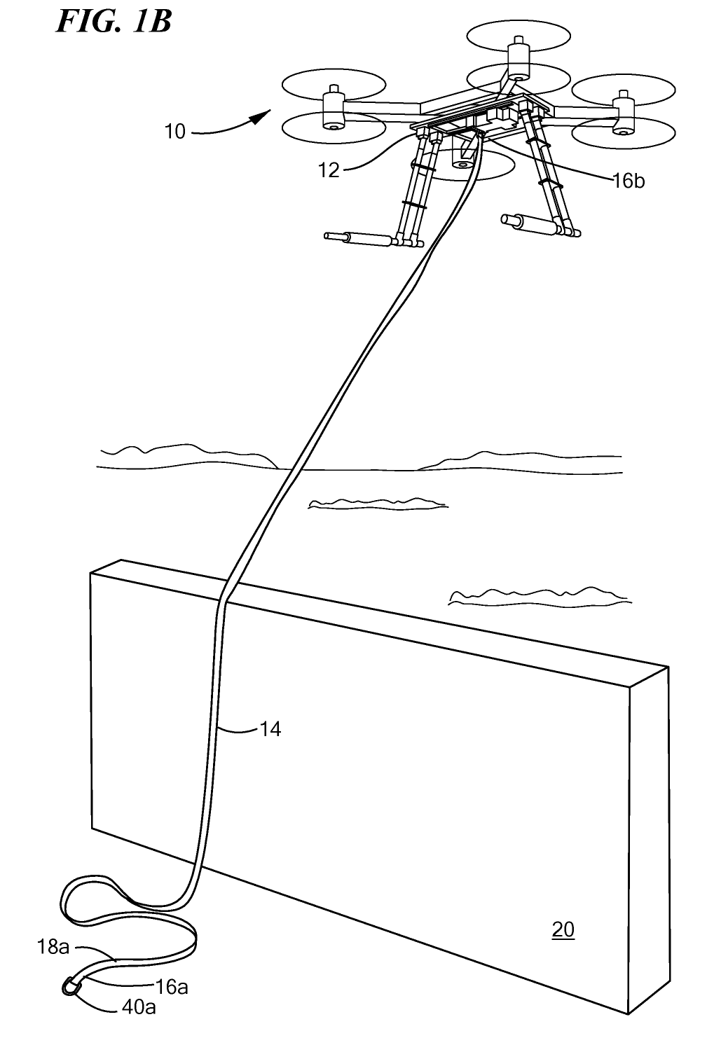

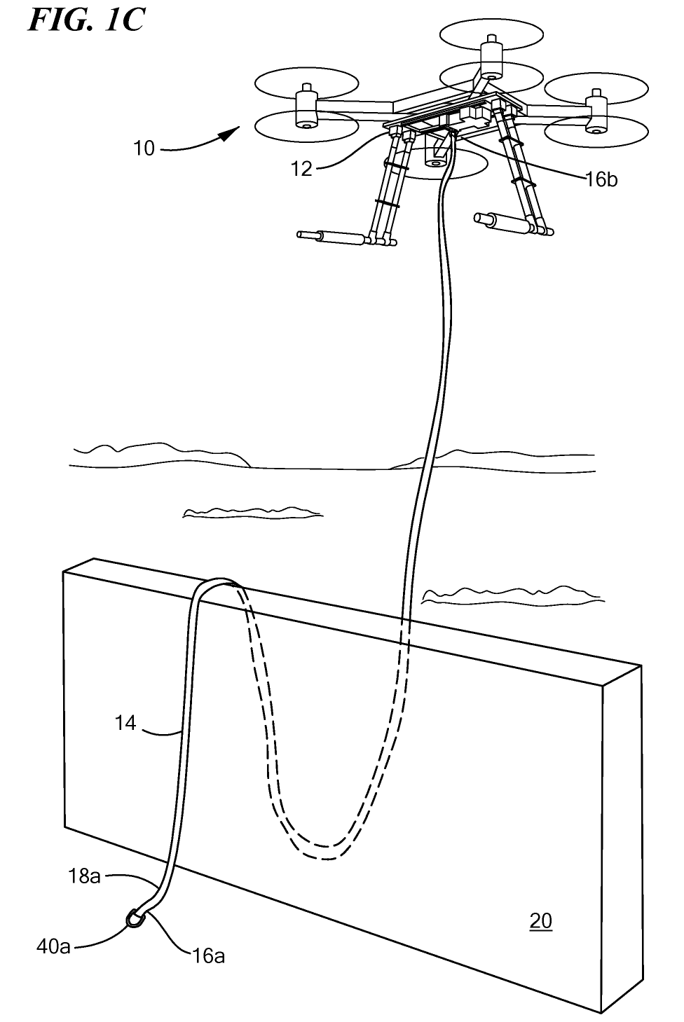

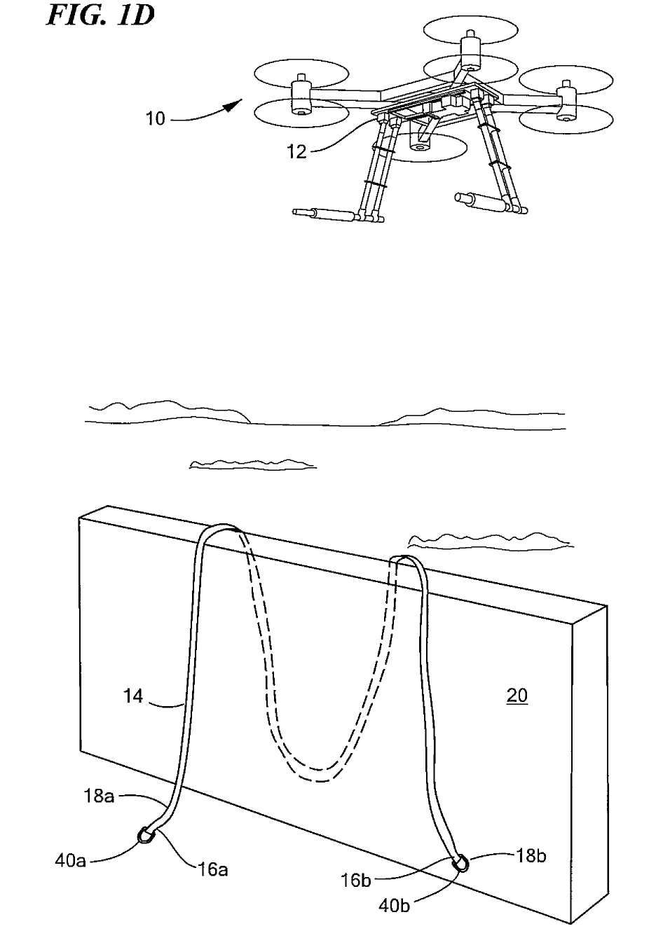

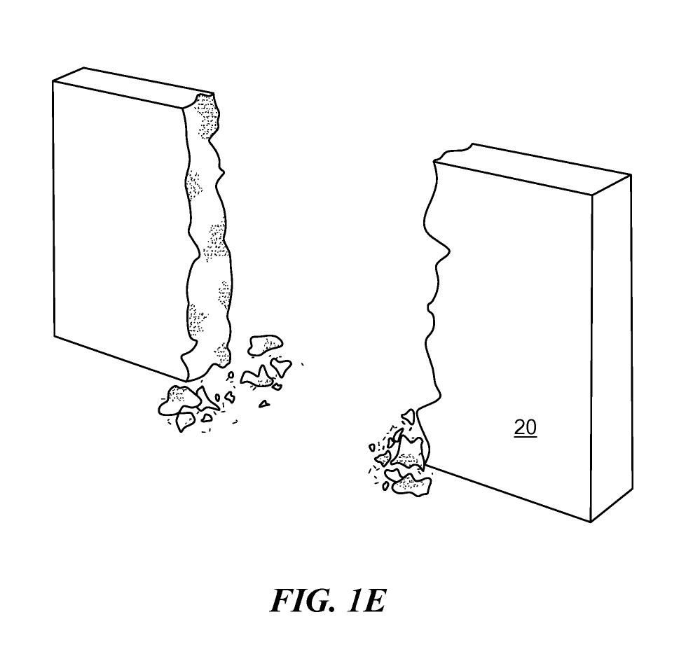

FIG. 1A shows unmanned aerial vehicle (UAV) 10, for example, a Harris Aerial, LLC (270 Bruner Road, Lexington, S.C. 29072), Stark Hx8 Power Series UAV with a payload capacity of up to 20 Kg or more. Other UAVs may be used in conjunction with the subject invention, however. UAV 10 has been remotely maneuvered to a first position proximate target 20, e.g., a barrier, wall, or fence using on-board cameras, for example.

A payload bay 12 is mounted beneath the UAV. Releasably secured to the UAV via the payload bay 12 is a first portion 16a (e.g., one end) of line charge 14 (see, e.g., U.S. Pat. No. 8,904,937). Also releasably secured to the UAV via payload bay 12 is a second portion of line charge 14, e.g., second opposite end 16b.

In FIG. 1B, first end 16a of line charge 14 has been released from the payload bay 12 and is deployed to a first deployment position 18a proximate target 20. In FIG. 1C, UAV 10 has been remotely maneuvered over target 20 draping line charge 14 thereover and in FIG. 1D, second end 16b of line charge 14 has been released and falls to a second deployment position 18b relative to target 20. Line charge 14 is now draped over target 20 from one side to the other and then back again as shown.

When the line charge 16 deployed in this manner is detonated as shown in FIG. 1E, the result is a wide area breach of the barrier 20 sufficient for passage of remotely or manually driven ground vehicles, multiple troops, or the like. The line charge may be remotely detonated using a tethered initiator. In other examples, a fuse is used.

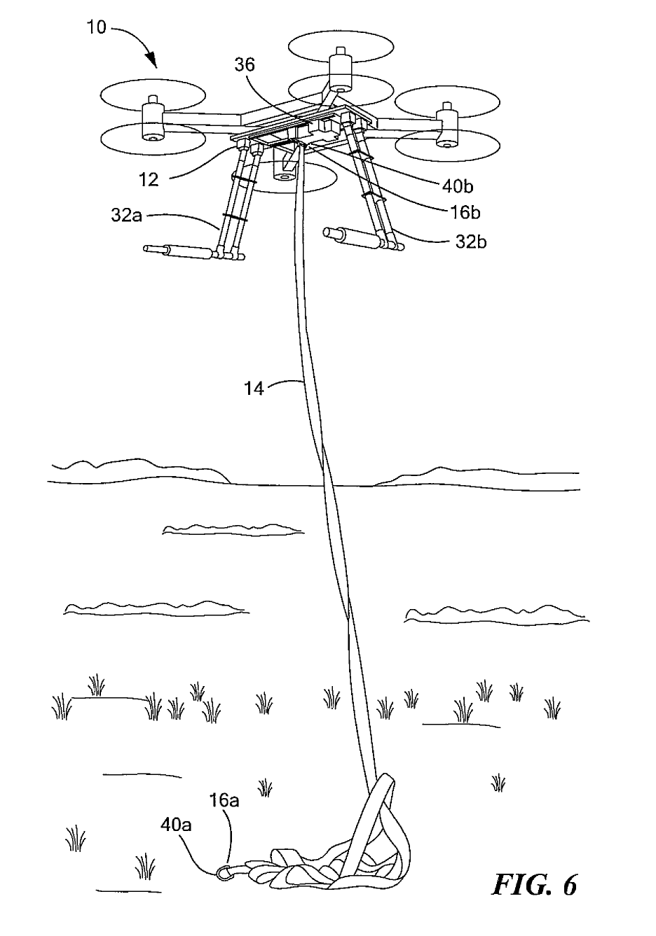

Similarly, the line charge can be more precisely deployed relative to other targets such as improvised explosive devices, concertina wire, and the like. In some examples, the line charge can be bundled using a strap in a manner such that releasing the first end of the line charge causes the strap to release unfurling the line charge. See FIG. 6. The two ends of the line charge can be released from the UAV when it is airborne or when it lands. After releasing one end of the line charge, the UAV can be maneuvered to drag the line charge over a target such as an obstacle or a complex geometry on the ground. The line charge may be 100 feet or more in length, 50 pounds or more in weight, and bundled in variable configurations and volumes. In the case of a tethered initiation, the UAV can be oriented inflight to account for the direction of the tether's origin.

This may all be accomplished non-line of sight and without using cameras. The UAV UPS antenna and mission planner can be used to manually input coordinates of exactly what the target geometry should look like. Take the simplest example of a straight line. The pilot could upload Stage 1 and Stage 2 release coordinates to the UAV flight computer and the UAV would autonomously drop the charge in a line between those two points. For other shapes, the pilot would just need to add additional steering and altitude adjustments in between the release points but deployment could still be executed autonomously.

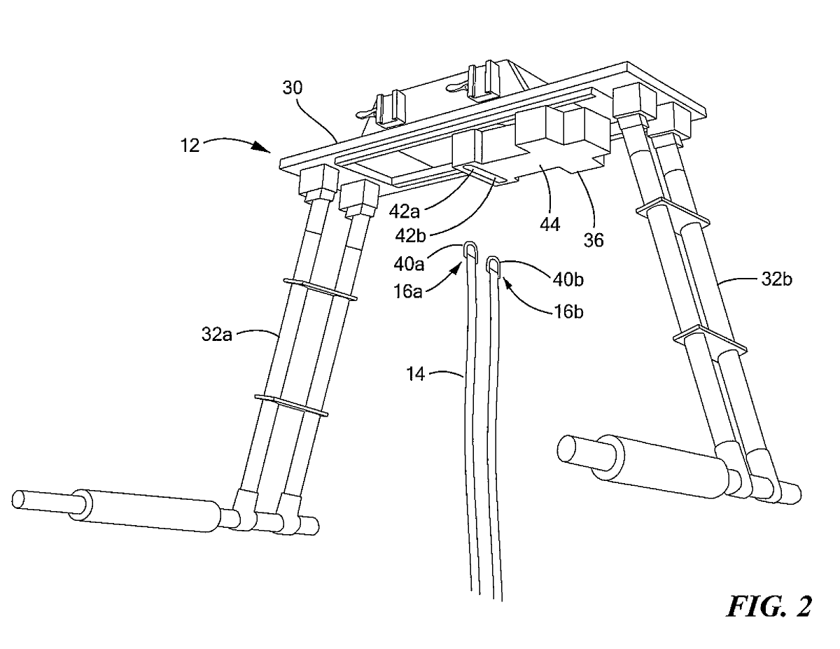

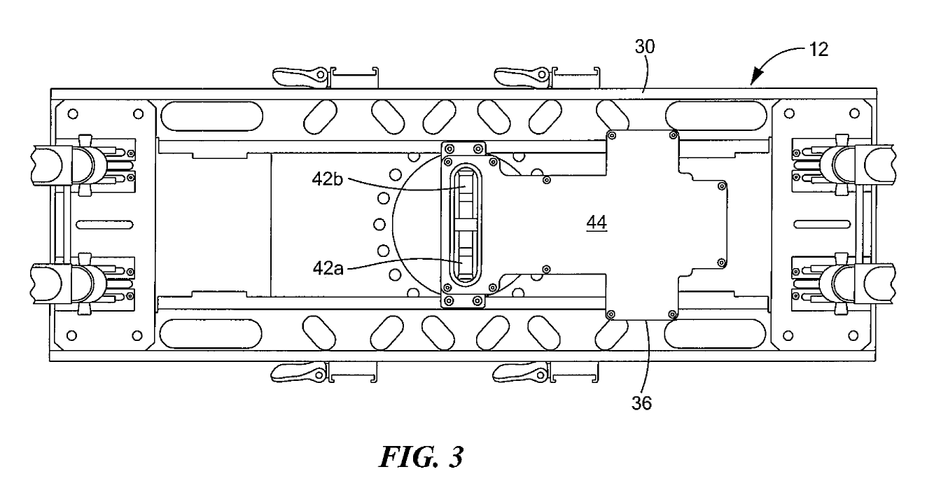

In one preferred embodiment, payload bay 21, FIG. 2, includes frame 30 mountable to the underside of a UAV using fasteners. Landing gear assemblies 32a and 32b may be foldably coupled to frame 30. A line charge release subsystem 36 is coupled beneath payload bay 21 frame 30 and preferably includes a first and second line charge release mechanisms for the first and second portions 16a, 16b, respectively, of the line charge. The first and second line charge release mechanisms can be remotely and independently activated. In this particular example, end 16a of line charge 14 is fitted with a loop 40a and end 16b of line charge 14 is fitted with a loop 40b. The loops may be fabric, string, or metal (e.g., D-rings). Loop 40a is accepted in and releasably secured within open-ended chamber 42a of housing 44 of release subsystem 36 and loop 40b is accepted in and releasably secured within open-ended chamber 42b of housing 44. See also FIG. 3.

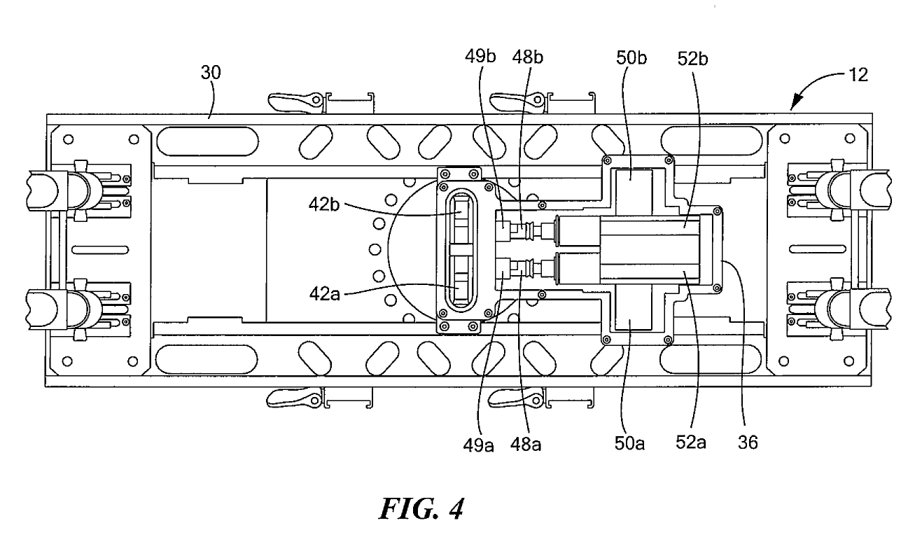

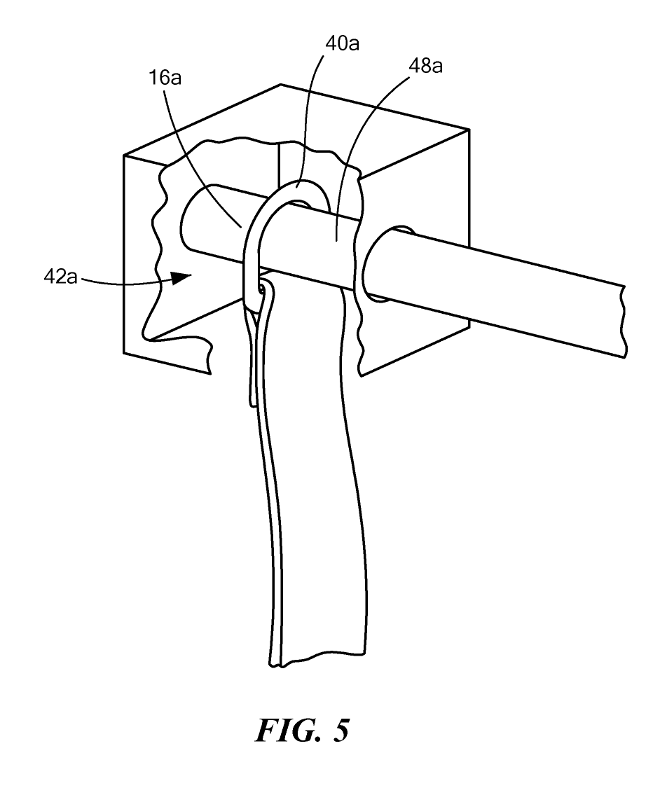

FIG. 4 shows an example when the first line charge release mechanism include first piston 48a driven by actuator 50a (e.g., a motor and a gear train assembly 52a) to a position extended across chamber 42a and within the first end loop of the line charge securing it within chamber 42a. See also FIG. 5. Similarly, the second line charge release mechanism in this example includes a second piston 48b independently driven by actuator 50a (a motor and gear train assembly 52b) to a position extending across chamber 42b and within the second end loop of the line charge securing it within open-ended chamber 42b. The pistons 48a, 48b may be extend and retract within cylinders 49a, 49b, respectively, which open into the chambers 42a, 42b, respectively.

By signaling the first and second actuators, the pistons 48a and 48b can be independently retracted from their respective chambers releasing the ends of the line charge typically at different times during maneuvering of the UAV. If the line charge is bundled via a strap or string, the strap or string can also be looped about one piston such that when the piston retracts, the strap or string is released from the line, charge enabling the line charge to unfurl and deploy. The UAV typically includes a controller (e.g., microcontroller) which electronically controls the actuators to extend and retract the pistons via radio commands generated at an operator control unit used to remotely operate the UAV. In this way, the pistons are independently controlled to first retract one piston and to later retract the other piston.

FIG. 6 shows one end 16a of line charge 14 released from the line charge release subsystem 36 and deployed on the ground and the other end 16b of the line charge 14 still releasably secured and coupled to the line charge release subsystem 36. In this way, the line charge can be laid out with respect to a target in a variety of shapes and configurations.

Besides pistons, the line charge release subsystem may include independently actuatable clasps, fingers, hooks, or the like, but the piston embodiment proved in testing to be a better design for reliably releasing the two ends or other portions of the line charge.

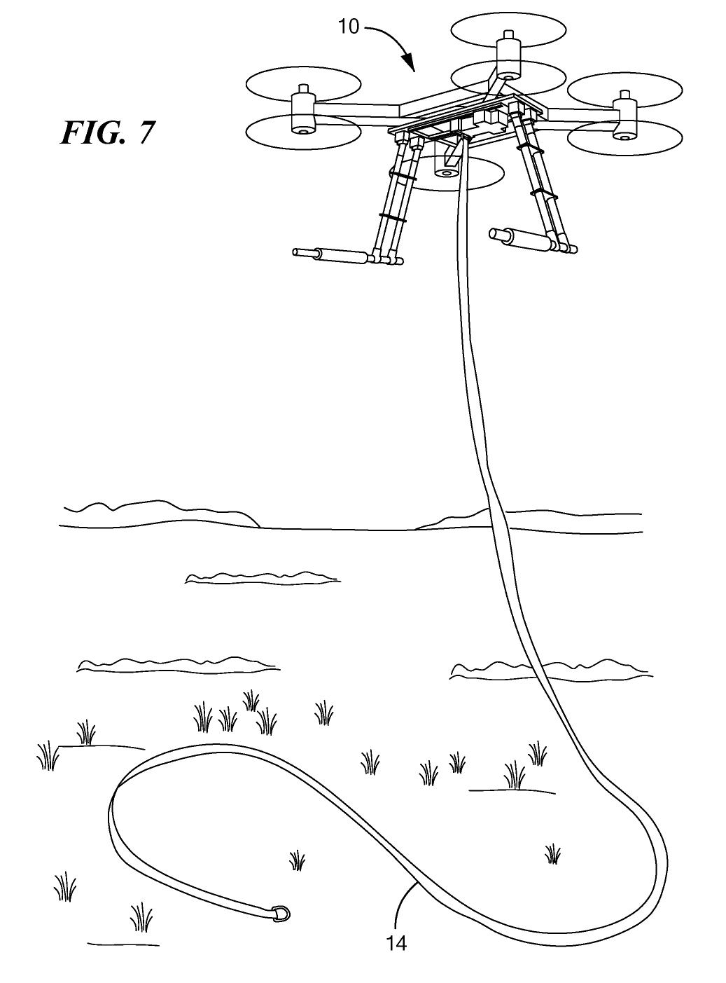

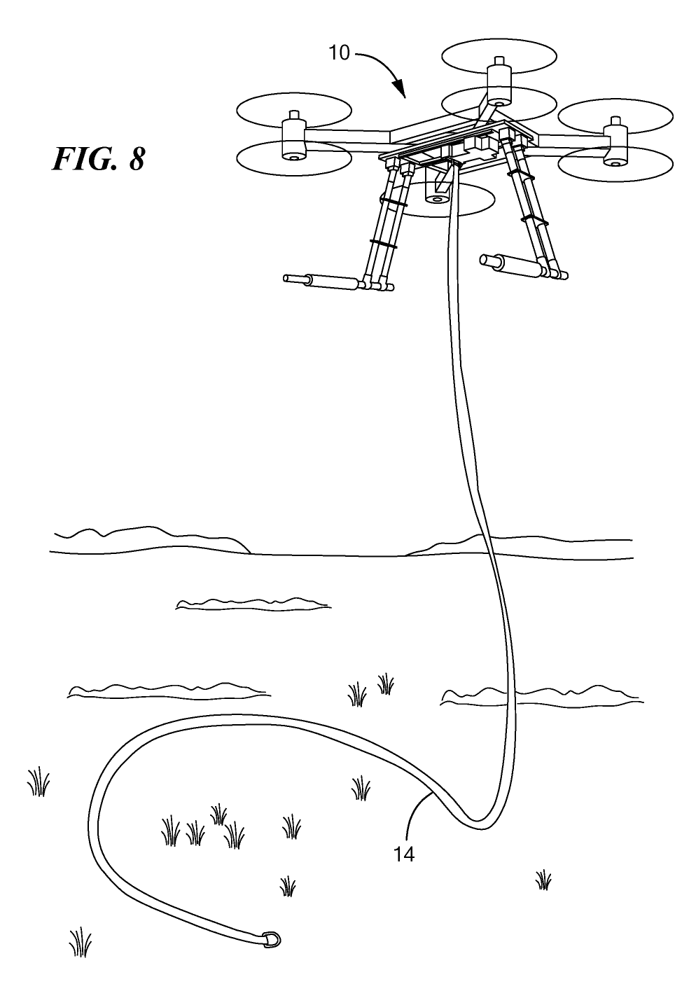

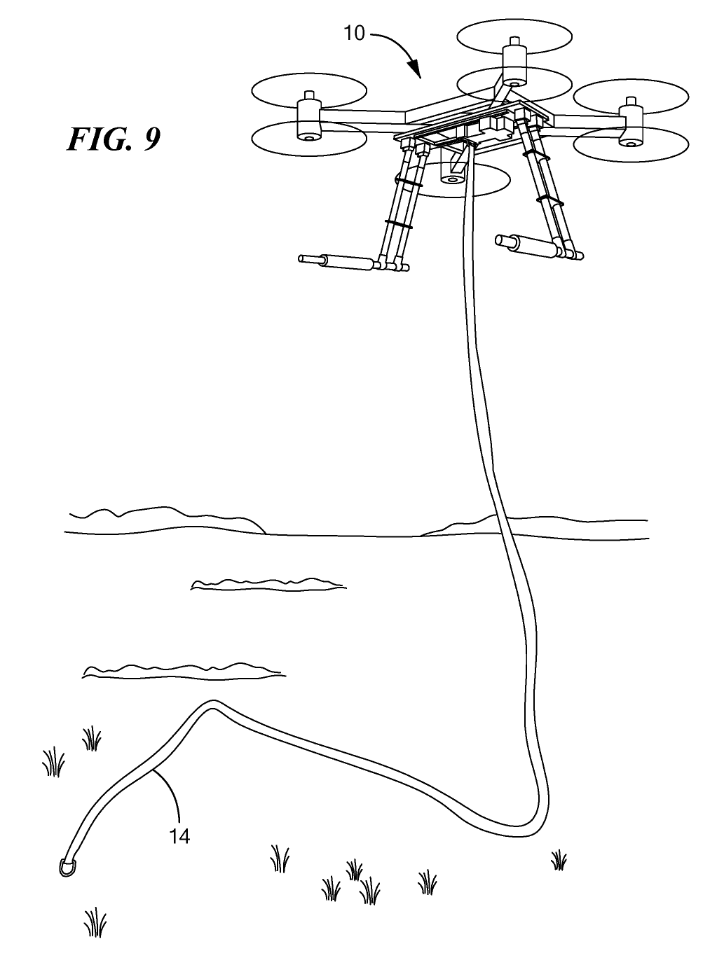

FIG. 7 shows a line charge 14 deployed on ground in an “S” shape. FIG. 8 shows a line charge 14 deployed on the ground in an arc, and FIG. 9 shows a line charge 14 deployed on the ground in an “L” shape.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant cannot be expected to describe certain insubstantial substitutes for any claim element amended.

Other embodiments will occur to those skilled in the art and are within the following claims.

What is claimed is:

1. An unmanned aerial vehicle line charge deployment system comprising:
an unmanned aerial vehicle;
a payload bay mounted beneath the unmanned aerial vehicle; and
a line charge release subsystem coupled to the payload bay and including:
a first line charge release mechanism for releasably securing a first portion of a line charge to the payload bay, and
a second line charge release mechanism, independent from the first line charge release mechanism, for releasably securing a second portion of the line charge to the payload bay.

2. The system of claim 1 in which the first line charge release mechanism includes a housing with a first open-ended chamber therein, a first piston, and a first actuator for driving the first piston into the first open-ended chamber releasably locking the said first portion of the line charge in the first open-ended chamber and for retracting the first piston with respect to the first open-ended chamber releasing said first portion of the line charge from the first open-ended chamber.

3. The system of claim 1 in which the second line charge release mechanism includes a second open-ended chamber in the housing, a second piston, and a second actuator for driving the second piston into the second open-ended chamber releasably locking the said second portion of the line charge in the second open-ended chamber and for retracting the second piston with respect to the second open-ended chamber releasing said second portion of the line charge from the second open-ended chamber.

4. An unmanned aerial vehicle line charge release subsystem comprising:
a first line charge release mechanism mountable to an unmanned aerial vehicle and configured to releasably secure a first portion of a line charge with respect to the unmanned aerial vehicle and to release the first portion of the line charge from the unmanned aerial vehicle; and
a second line charge release mechanism mountable to the unmanned aerial vehicle and configured to releasably secure a second portion of the line charge with respect to the unmanned aerial vehicle and to independently release the second portion of the line charge from the unmanned aerial vehicle.

5. The subsystem of claim 4 in which the first line charge release mechanism includes a housing with a first open-ended chamber therein, a first piston, and a first actuator for driving the first piston into the first open-ended chamber locking the said first portion of the line charge in the first open-ended chamber and for retracting the first piston with respect to the first open-ended chamber releasing said first portion of the line charge from the first open-ended chamber.

6. The system of claim 4 in which the second line charge release mechanism includes a second open-ended chamber in the housing, a second piston, and a second actuator for driving the second piston into the second open-ended chamber locking the said second portion of the line charge in the second open-ended chamber and for retracting the second piston with respect to the second open-ended chamber releasing said second portion of the line charge from the second open-ended chamber.

7. A method of deploying a line charge, the method comprising:
releasably securing a first portion of the line charge with respect to an unmanned aerial vehicle;
releasably securing a second portion of the line charge with respect to the unmanned aerial vehicle;
maneuvering the unmanned aerial vehicle to a first position proximate a target;
releasing said first portion of the line charge from the unmanned aerial vehicle to a first deployment position;
maneuvering the unmanned aerial vehicle to a second position proximate the target; and
releasing said second portion of the line charge from the unmanned aerial vehicle to a second deployment position.

8. The method of claim 7 in which releasably securing the first portion of the line charge to the unmanned aerial vehicle includes extending a first piston to secure the first portion of the line charge relative to the unmanned aerial vehicle and releasing said first portion of the line charge from the unmanned aerial vehicle includes retracting the first piston.

9. The method of claim 7 in which releasably securing the second portion of the line charge to the unmanned aerial vehicle includes extending a second piston to secure the second portion of the line charge relative to the unmanned aerial vehicle and releasing said second portion of the line charge from the unmanned aerial vehicle includes retracting the second piston.

10. The method of claim 7 further including remotely detonating the line charge.

11. An unmanned aerial vehicle line charge deployment system comprising:
an unmanned aerial vehicle;
a payload bay mounted beneath the unmanned aerial vehicle; and
a line charge release subsystem coupled to the payload bay and including:
a first line charge release piston for releasing a first portion of a line charge from the payload bay, and
a second line charge release piston for releasing a second portion of the line charge from the payload bay
